(19) United States
(12) Patent Application Publication
(10) Pub. No.: US 2021/0345796 A1
(43) Pub. Date: Nov. 11, 2021

(54) Word Vase

(71) Applicant: Syed Abraham Ahmed, Houston, TX (US)

(72) Inventor: Syed Abraham Ahmed, Houston, TX (US)

(21) Appl. No.: 17/365,856

(22) Filed: Jul. 1, 2021

(51) Int. Cl. A47G 7/06; A01G 9/02

(52) U.S. Cl. CPC A47G 7/06; A01G 9/02

(57) ABSTRACT

The word vase is an actual word or multiple words together or date or phrase or name or numbers used as a vase to put plants, or flowers, or tree inside.

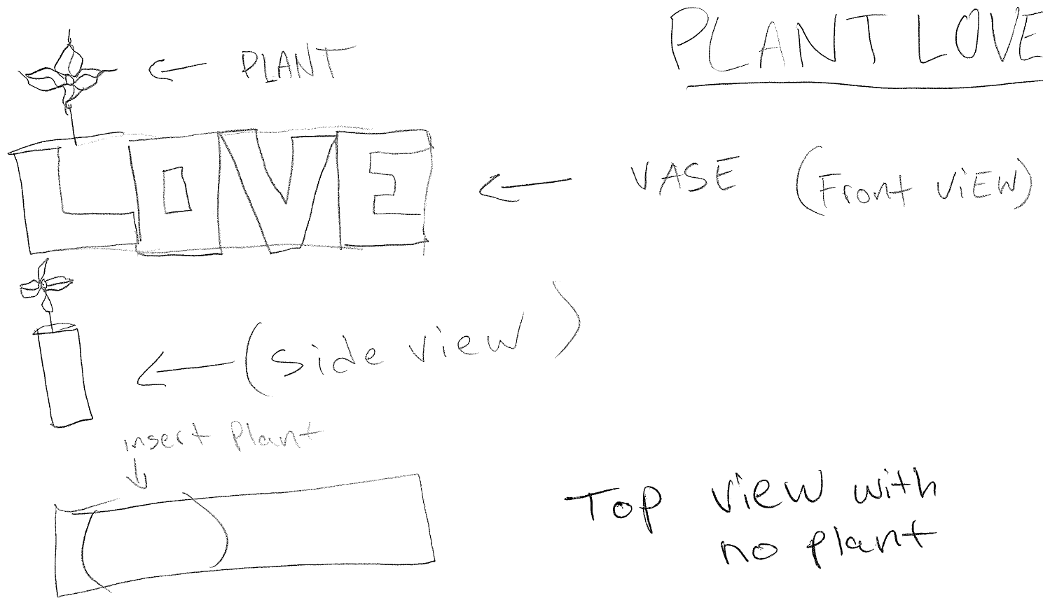

The vase is an actual word made of ceramic, wood, concrete, crystal, plastic, metal, stone or any other material that is formed and used as a flowerpot. The phrase “plant hope” “Plant love” “Plant inspiration” “Plant education” are examples of how the word vase is utilized. Plant anything in direct correlation to the vase are all trademarks in conjunction with the design of the word vase. It is an actual buildout of a word that is being used to hold a plant or flower or tree inside. The vase can be made in any language and any font and any size of the vase in conjunction with a word, name, multiple words together, date, or number.

The word vase is an actual word or multiple words together or date or phrase or name or numbers used as a vase to put plants, or flowers, or tree inside.

The vase is an actual word made of ceramic, wood, concrete, crystal, plastic, metal, stone or any other material that is formed and used as a flowerpot. The phrase “plant hope” “Plant love” “Plant inspiration” “Plant education” are all examples of how the word vase is being utilized. Plant anything in direct correlation to the vase are all trademarks in conjunction with the design of the word vase. It is an actual buildout of a word that is being used to hold a plant or flower or tree inside. The word vase can be a word that is used as a vase, flowerpot, planter, or flats, or biodegradable material, or alternatively a container in which flowers or trees or plants are cultivated and displayed. The vase can be made in any language and any font and any size of the vase in conjunction to it is a word, name, multiple words together, date, or number.

1. The word vase is an object that can be a word or date or name or multiple words together or number that is made out of a material to be used as a plant pot.
a. The word vase is designed to look like the actual word.
b. The word vase can be made out of ceramic, wood, concreate, crystal, plastic, metal, stone, or any other material that is formed and used as a flowerpot and a word or number or date or name or multiple words together.
c. The word vase has a plant or tree, or flower inserted inside of it.
d. The plant or tree or flower is inserted from the top of the vase.
e. The word vase is an actual buildout of a word that is being used to hold a plant or flower or tree inside.
f. The phrase “plant hope” “Plant love” “Plant inspiration” “Plant education” while referring to putting a plant inside of a vase that is shaped to the word or phrase or number; are all examples or how the word vase is being utilized in direct correlation to the vase are all trademarks in conjunction to the word vase.
g. The vase can be made in any language and any font and any size of the vase in conjunction to it being a word, name, multiple words together, date, or number.
